(19) United States
(12) Patent Application Publication
(10) Pub. No.: US 2005/0120203 A1
(43) Pub. Date: Jun. 2, 2005

(54) Methods, systems and computer program products for automatic rekeying in an authentication environment

(76) Inventors: Ryhwei Yeh, Palo Alto, CA (US); Haili Ma, San Jose, CA (US); Samuel Kim, Saratoga, CA (US)

Correspondence Address: MYERS BIGEL SIBLEY & SAJOVEC, PO BOX 37428, RALEIGH, NC, 27627, US

(21) Appl. No.: 10/725,043

(22) Filed: Dec. 1, 2003

(51) Int. Cl. H04L 9/00

(52) U.S. Cl. 713/156; 380/277

(57) ABSTRACT

Rekeying in an authentication system including an authenticated data processing system and an authenticating data processing system is provided by the authenticating data processing system detecting failure of an authentication of the authenticated data processing system with a current public key associated with the authenticated data processing system and automatically updating the current public key associated with the authenticated data processing system with an updated public key responsive to detecting failure of an authentication of the authenticated data processing system with the current public key. Automatic rekeying of a client in a server-side authentication system is provided. Automatic rekeying may occur upon detection by the client that server authentication has failed. The automatic rekeying may include requesting an updated key from a server. The request may include an identification of the current public key of the client and the server may access a repository of previous keys to sign the updated public key sent to the client with a private key corresponding to the current public key of the client.

### FIELD OF THE INVENTION

The present invention relates generally to network communications and more particularly to the authentication of a server.

### BACKGROUND OF THE INVENTION

With increased use of the Internet for communicating confidential or sensitive information, techniques have been developed for providing secure communications over networks. Such security may provide for confidentiality of the communications themselves and/or assurance that information is provided to an intended recipient or received from a known server. Confidentiality of the communications may, for example, be provided by encryption of the contents of the communications. The communications may be encrypted before transmission, for example, using an encryption application, such as PGP or the like, and/or may be encrypted as part of a secure communication, such as using a Secure Sockets Layer (SSL), Transport Layer Security (TSL) and/or Internet Protocol Security (IPSEC) connection.

Assurance that the information is being provided to an intended recipient may be provided, for example, using authentication techniques, such as server-side authentication. Authentication techniques may reduce the likelihood that a recipient of information may be “spoofed” or impersonated and the information surreptitiously obtained. One authentication technique provides for server authentication using a signed certificate to authenticate a server. When a client makes a connection to a server, the server sends the signed certificate to the client. The certificate is signed with a private key for which the client has the public key, for example, using an RSA encryption technique. The client attempts to verify the signature of the certificate with the public key associated with the server. If the client verifies the signature of the certificate successfully using the public key associated with the server, the server is authenticated.

As a particular example of the use of server-side authentication, AppManager 5.0.1, available from NetIQ Corporation of San Jose, Calif., provides for management agents of the management system to communicate with a management server using an SSL connection with server authentication. When the agent contacts the management server, the agent establishes an SSL connection and receives a certificate from the management server that is signed by the management server to authenticate the server to the client. The agent uses the public key associated with the network monitoring server to verify the signature of the certificate and authenticate the server.

Given enough time and resources, the private key portion may be derived from the public key. In that case, the identity of the server and any communication between the server and client may be compromised. To further decrease the likelihood that a server may be impersonated, it may be beneficial to periodically change the public/private key pair utilized in the authentication process. This process has been referred to as “rekeying.” To perform such a change, however, the key pair must, typically, be changed at the server and each of the agents. If an agent has an out of date public key, it will be unable to correctly verify the signature of the certificate signed with the new private key of the server, despite the server being the authentic server to which the agent intended to connect.

When “rekeying” of a server and agents occurred, conventionally, a manual process was used that involved exporting the new public/private key pair and importing the keys to replace the old keys used by the agents. The agents would, typically, be rebooted with the new keys to begin use of the keys. Such a manual operation could be time and cost consuming as well as risking a compromise of security during the manual export/import process.

Conventionally, a solution to the rekeying issues was to manually create a new public key certificate and place it in the client machine to replace the old certificate. However, this type of manual process may not scale to an environment with a large number of client machines.

Another conventional solution is to send the new public key certificate over an existing security channel from the server application to the client application, and programmatically synchronize both sides to switch to the new set of keys at a specific later time. This type of solution relies on the conditions that both the server and client machines are synchronized in their system time and the client application is running and connected to the server application at the time of transmitting the new public key certificate. Also, in this scenario, if a client does not receive a key, then there may be no way for the client to securely communicate with the server.

A further conventional solution is that the server application keeps a non-authenticated channel open at all times for the client application to request a new public key certificate when needed. Solutions such as this, however, may open a security hole from and extensive period of time.

### SUMMARY OF THE INVENTION

Embodiments of the present invention provided for rekeying in an authentication system including an authenticated data processing system and an authenticating data processing system. The authenticating data processing system detects failure of an authentication of the authenticated data processing system with a current public key associated with the authenticated data processing system and automatically updates the current public key associated with the authenticated data processing system with an updated public key responsive to detecting failure of an authentication of the authenticated data processing system with the current public key.

Certain embodiments of the present invention provide for rekeying in a server-side authentication system including a client and a server. In particular embodiments of the present invention, a client of the server detects failure of an authentication of the server with a current public key associated with the server. The client automatically updates the public key associated with the server with an updated public key responsive to detecting failure of authentication with the client's current public key. The authentication failure may be detected, for example, by receiving a signed certificate from the server and failing to verify the signed certificate with the current public key.

In further embodiments of the present invention, the public key associated with the server is automatically updated by establishing a connection to an authentication server, which may or may not be the authenticated server itself, requesting the updated public key from the authentication server over the connection, receiving the updated public key and replacing the current public key with the updated public key. The connection to the authentication server may, for example, be a secure connection to the server, such as a Secure Sockets Layer encryption only connection.

In additional embodiments of the present invention, the updated public key is requested from the authentication server by sending a request for an updated public key to the authentication server. The request includes an identification of the current public key. The identification of the current public key may be a checksum of the current public key.

In yet further embodiments of the present invention, receiving the updated public key includes receiving the updated public key signed with a private key corresponding to the current public key and verifying the received signed updated public key with the current public key.

In particular embodiments of the present invention, the server is a system monitoring server and the client is a resource monitoring agent.

In still further embodiments of the present invention, rekeying in a server-side authentication system including a server, is provided by the server receiving a request for an updated public key from a client over a connection established responsive to the client detecting failure of an authentication of the server by the client and providing the updated public key from the server to the client responsive to receiving the request for the updated public key from the client. The connection may be an encryption only secure connection to the server, such as a Secure Sockets Layer encryption only connection. However, this level of communication may be non-encrypted as well. In other words, the rekeying may take place in non-encrypted mode. Non-encrypted mode may not compromise security because only public keys may be exposed.

In additional embodiments of the present invention, the request for an updated public key includes an identification of a current public key of the client. The identification of the current public key may be a checksum of the current public key. The client may also be validated as authorized to request an updated public key based on the identification of the current public key of the client.

In some embodiments of the present invention, a private key is selected from a repository of public/private key pairs based on the identification of the current public key. The updated public key may be provided by signing the updated public key utilizing the selected private key and sending the signed updated public key to the client over the secure connection. If the communication is to take place in non-encrypted mode, the updated public key may still be signed with the private key, however, the communication of the signed updated public key may not be encrypted.

In still other embodiments of the present invention, the current public/private key pair of the server is stored in a key repository. Additionally, an authentication certificate or public key of the server may be signed with the updated private key. To further decrease the likelihood of a key compromise, the user can remove one or more of the historic keys stored in the key repository. By a judicious schedule of rekeying (for example, at a frequency of about 1/2 the expected time to break the key) and removal of old keys, the compromise of the secure authenticated communication between the client and the server may be highly unlikely.

In yet additional embodiments of the present invention, the client further automatically requests updating of the current public key of the client associated with the server with an updated public key responsive to detecting failure of an authentication of the server with the current public key. The client may detect failure of an authentication of the server by receiving a signed certificate from the server and failing to verify the signed certificate with the current public key. The client may also receive the updated public key from the server and replace the current public key with the updated public key. Receiving the updated public key may include receiving the updated public key signed with a private key corresponding to the current public key and verifying the received signed updated public key with the current public key.

In yet additional embodiments of the present invention, a system for rekeying a server-side authentication system includes a first client configured to detect failure of the first client to authenticate an authenticated server and to automatically request an updated public key associated with the authenticated server for which an authentication failure was detected. An authentication server is configured to receive requests for updated public keys from the first client and send updated public keys to the first client. A key repository may also be provided operably associated with the authentication server. The key repository is configured to store previous public/private key pairs associated with the authenticated server. The authenticated server and the authentication server may be the same or different servers.

In further embodiments of the present invention, the authentication server is further configured to select a public/private key pair from the key repository corresponding to a current public key of the first client from which the request was received and sign the updated public key with a private key of the selected public/private key pair. The first client may also be configured to receive the updated public key from the authentication server and verify the signature of the received updated public key with the current public key of the first client.

In additional embodiments of the present invention, a second client is configured to detect failure of the second client to authenticate an authenticated server and automatically request an updated public key associated with the authenticated server for which authentication failure was detected. The authentication server is further configured to receive requests for updated public keys from the second client and send updated public keys to the second client. The authentication server may also be configured to select a public/private key pair from the key repository corresponding to a current public key of the first client from which the request was received and sign the updated public key with a private key of the selected public/private key pair and to select a public/private key pair from the key repository corresponding to a current public key of the second client from which the request was received and sign the updated public key with a private key of the selected public/private key pair. The selected public/private key pair from the key repository corresponding to a current public key of the second client and the selected public/private key pair from the key repository corresponding to a current public key of the first client may be different public/private key pairs.

In still further embodiments of the present invention, rekeying in an authentication system having an authenticated communication includes an authenticating data processing system that detects failure of an authentication of an authenticated communication with a current public key associated with a source of the authenticated communication and automatically updates the current public key associated with the source of the authenticated communication with an updated public key responsive to detecting failure of an authentication of the authenticated communication with the current public key. In certain embodiments, the authenticated communication includes a signed certificate, the authenticating data processing system is a client and the source of the authenticated communication is a server. In other embodiments, the authenticated communication includes a signed certificate, the authenticating data processing system is a server and the source of the authenticated communication is a client.

In additional embodiments of the present invention, the authenticated communication includes an e-mail message. In such embodiments, the authenticating data processing system may be a mail recipient and the source of the authenticated communication may be a source of the e-mail message. The source of the e-mail message may be an author of the e-mail and/or an e-mail server.

As will further be appreciated by those of skill in the art, while described above primarily with reference to method aspects, the present invention may be embodied as methods, apparatus/systems and/or computer program products.

### BRIEF DESCRIPTION OF THE FIGURES

FIG. 1 is a block diagram of a server-side authentication system according to embodiments of the present invention.

FIG. 2 is a block diagram of a data processing system suitable for use as a client and/or server in embodiments of the present invention.

FIG. 3 is a more detailed block diagram of aspects of a data processing system that may be used in embodiments of the present invention.

FIG. 4 is a flow chart of operations carried out by a client according to embodiments of the present invention.

FIG. 5 is a flow chart illustrating operations carried out by a server according to embodiments of the present invention.

FIG. 6 is a block diagram illustrating messaging between an authentication server and a client according to embodiments of the present invention.

FIG. 7 is a flow chart illustrating operations carried out by a client according to particular embodiments of the present invention.

FIG. 8 is a flow chart illustrating operations carried out by a server when encryption keys are changed according to particular embodiments of the present invention.

FIG. 9 is a flow chart illustrating operations carried out by a server for distributing new keys to clients according to particular embodiments of the present invention.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described in part below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

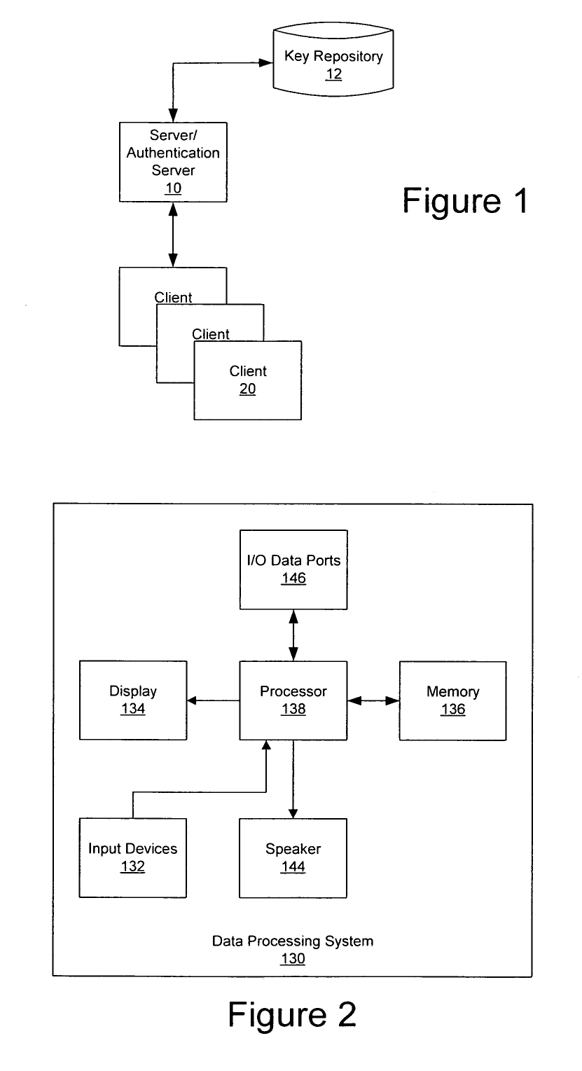

Embodiments of the present invention provide for automatic rekeying of a client that utilizes server authentication. As used herein, automatic and automatically refer to an operation that is carried out without human intervention. Various embodiments of the present invention will now be described with reference to the figures. FIG. 1 illustrates a system according to embodiments of the present invention. As seen in FIG. 1, a server/authentication server 10 (e.g., a server to be authenticated by a client and a server that stores historic key pairs to validate update key requests and transmit updated keys to a client) communicates with one or more clients 20, for example, over a network, such as a packet switched network. The network may, for example, be a local area network, a wide area network, a private network, a public network, the Internet and/or an extranet. The network could also be a satellite or other wireless network, such as those provided by cellular telephone networks, satellite television networks, satellite telephone networks or other such networks.

In particular embodiments of the present invention, the client 20 may be a resource monitoring agent and the server 10 may be a system monitoring application such as those provided by AppManager from NetIQ. As illustrated in FIG. 1, the server that is authenticated and the authentication server that provides public keys to a client may be a single server (server/authentication server 10). However, the server and the authentication server may be separate servers, separate applications on a single platform and/or a single application and, thus, should not be limited to the particular arrangement illustrated in FIG. 1.

In certain embodiments of the present invention, the server/authentication server 10 provides a signed certificate to the client 20 so as to authenticate the server/authentication server 10 to the client 20. The server/authentication server 10 also maintains a key repository 12 of historical public/private key pairs that have been used previously for authentication. When the server/authentication server 10 is rekeyed (i.e., the public/private key pair for authentication is changed), the previous public/private key pair are stored in the key repository 12. Such a key repository 12 may be used as described herein for clients 20 that only intermittently connect to the server/authentication server 10. Thus, for example, if rekeying occurs once a week but a client 20 only connects once a month, the key repository 12 may allow the server/authentication server 10 to identify the current key of the client 20 even if it is not the most recent previously used public key of the server/authentication server 10. While the key repository 12 may take different forms, the key repository may be incorporated as part of a system monitoring database such as the AppManager (QDB) database.

The client 20 maintains a current public key of a public/private key pair associated with the server/authentication server 10. The public key is utilized to authenticate a certificate received from the server/authentication server 10. If the client 20 detects that authentication of the server/authentication server 10 has failed, the client 20 requests a new (updated) public key from the server/authentication server 10. The server/authentication server 10 sends the new public key to the client 20 responsive to the request and signs the new public key with the private key of the public/private key pair from the key repository 12 that is currently used by the client 20. The client 20 receives the new public key, verifies the signature of the new public key with the current public key of the client and replaces the current public key with the new public key for use in authenticating the server/authentication server 10.

While embodiments of the present invention are primarily described herein with reference to a single client and a single server, embodiments of the present invention may include other numbers of clients and/or servers. Furthermore, while embodiments of the present invention are illustrated with reference to requesting an updated public key from the server for which authentication has failed, such a request may be made to a different server (e.g., an authentication server). For example, if a client fails to authenticate a first server, the client may connect to a second server to request a new public key for authentication of the first server. Thus, the first server may be referred to as an authenticated server and the second server may be referred to as an authentication server. The authenticated server and the authentication server may be the same or different devices. Thus, embodiments of the present invention are not limited to the particular configuration illustrated in FIG. 1 as such is merely exemplary and should not be construed as limiting.

Furthermore, the key repository 12 may be resident on the server/authentication server 10 and/or remote from the server/authentication server 10. However, irrespective of whether the key repository 12 is resident on the server 10 or remote from the server 10, if communications with the key repository 12 are not secure, the security of the information stored in the key repository may be compromised. Thus, in certain embodiments of the present invention where the key repository is remote from the server 10, communications with the key repository 12 are carried out in a secure manner (e.g. over a secure connection, secure communication media and/or within a controlled network environment). The key repository 12 may also include security measures, such as password protection and/or encryption. For example, the key repository 12 may take the form of a password protected file and/or database.

FIG. 2 illustrates an exemplary embodiment of a data processing system 130 suitable for use as an authentication server 10 and/or client 20 in accordance with some embodiments of the present invention. The data processing system 130 typically includes input device(s) 132 such as a keyboard, pointer, mouse and/or keypad, a display 134, and a memory 136 that communicate with a processor 138. The data processing system 130 may further include a speaker 144, and an I/O data port(s) 146 that also communicate with the processor 138. The I/O data ports 146 can be used to transfer information between the data processing system 130 and another computer system or a network. These components may be conventional components, such as those used in many conventional data processing systems, which may be configured to operate as described herein.

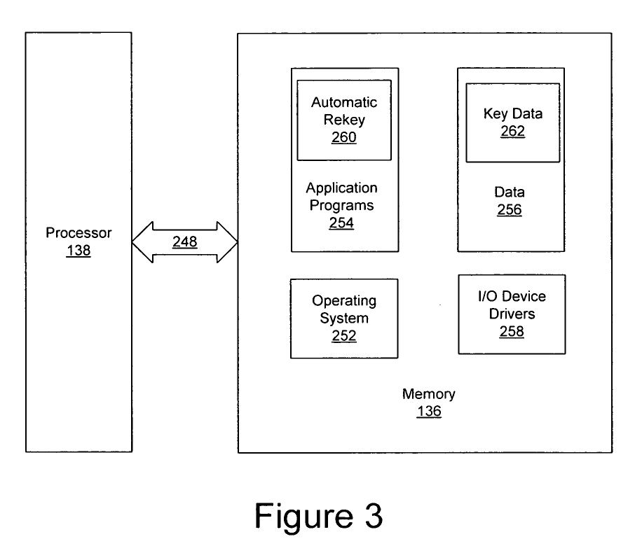

FIG. 3 is a block diagram of data processing systems that illustrates systems, methods, and computer program products in accordance with some embodiments of the present invention. The processor 138 communicates with the memory 136 via an address/data bus 248. The processor 138 can be any commercially available or custom microprocessor. The memory 136 is representative of the overall hierarchy of memory devices, and may contain the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 3, the memory 136 may include several categories of software and data used in the data processing system 130: the operating system 252; the application programs 254; the input/output (I/O) device drivers 258; and the data 256, which may include hierarchical data sets. As will be appreciated by those of skill in the art, the operating system 252 may be any operating system suitable for use with a data processing system, such as OS/2, AIX, System390 or z/OS from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 130 and preferably include at least one application that supports operations according to embodiments of the present invention. Finally, the data 256 represents the static and dynamic data used by the application programs 254, the operating system 252, the I/O device drivers 258 and other software programs that may reside in the memory 136.

As is further seen in FIG. 3, the application programs 254 may include an automatic rekey module 260. The automatic rekey module 260 may carry out the operations described herein for a server and/or client to rekey a client for server-side authentication utilizing key data, such as the key data 262. While the present invention is illustrated, for example, with reference to the automatic rekey module 260 being an application program in FIG. 3, as will be appreciated by those of skill in the art, other configurations may also be utilized. For example, the automatic rekey module 260 may also be incorporated into the operating system 252, the I/O device drivers 258 or other such logical division of the data processing system 130. Thus, the present invention should not be construed as limited to the configuration of FIG. 3 but encompasses any configuration capable of carrying out the operations described herein.

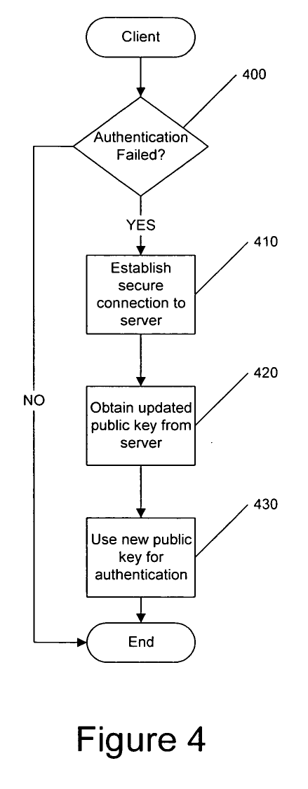

Operations of a client 20 according to particular embodiments of the present invention are illustrated in FIG. 4. As seen in FIG. 4, if the client 20 detects that authentication of the server 10 fails (block 400), the client 20 establishes a secure connection to the server 10 (block 410). The client 20 may detect that authentication of the server 10 has failed, for example, by failing to verify a signed certificate received from the server 10. In particular, the client 20 may attempt to establish an SSL connection with authentication to the server 10 and, if such an attempt fails, the client 20 may establish an encryption only SSL session to the server 10. Other types of secure connections may also be utilized. Optionally, a non-secure connection may be utilized, however, such may risk compromising the security of the rekeying transaction.

After establishing the secure connection to the server 10, the client 20 obtains an updated public key from the server 10 (block 420). The new public key may be obtained, for example, responsive to a request from the client 20 and may be signed, for example, using the corresponding private key to the current public key of the client 20. The client 20 then uses the new public key for future authentication of the server 10 (block 430), for example, by replacing the current public key of the client 20 with the new, updated, public key. By signing the new public key with the private key corresponding the current public key, the client 20 may also validate the new public key as a failure to verify the signed new public key would indicate that the new public key was not valid. Thus, the ability to impersonate or spoof the server by forcing the client to fail authentication with an impersonating server and then having the impersonating server send a new public key that the client would utilize for future communications may be reduced by the signing of the new public key.

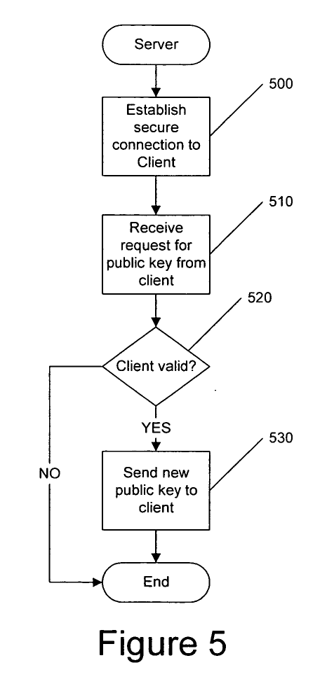

Operations of a server/authentication server 10 according to particular embodiments of the present invention are illustrated in FIG. 5. The operations illustrated in FIG. 5 may occur after a public/private key pair of the server/authentication server 10 has been changed, either manually by, for example, a system administrator, or automatically as part of the operations of the server 10. As seen in FIG. 5, the server/authentication server 10 establishes a secure connection with the client 20 (block 500). Establishing a secure connection maybe initiated by the client 20, for example, responsive to failing to authenticate the server/authentication server 10 as described above with reference to FIG. 4. As discussed above, optionally, a non-secure connection may be utilized, however, such may risk compromising the security of the rekeying transaction.

The server/authentication server 10 receives a request for an update public key from the client 20 over the connection (block 510). The server/authentication server 10 validates the request from the client 20 (block 520). Such a validation may, for example, include an identification of a previous public key utilized by the client 20. The validation could also include user/password verification, authentication of the client 20, access policy compliance verification and/or other such techniques for verifying that the request for a new public key is from an authorized client. If the client is not valid (block 520), then the request is not honored. Optionally, an error report may be generated identifying information regarding the failing request, including, for example, the source of the request and the nature of the failure. Such a report may, for example, be utilized to detect attempts at spoofing or impersonating a client 20 so as to obtain an updated public key. If the client is valid (block 520), the server/authentication server 10 sends the new public key to the client 20 over the connection (block 530). The new public key may, for example, be encrypted with the private key corresponding to the current public key of the client 20 that the server/authentication server 10 determines based on the identification of the previous public key and information from the key repository 12.

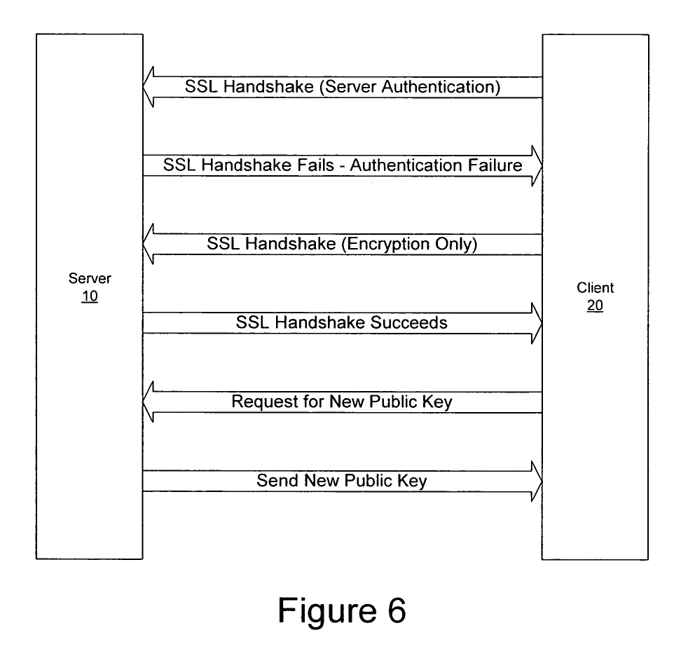

Communications between a client 20 and a server/authentication server 10 according to particular embodiments of the present invention utilizing SSL connections are illustrated in FIG. 6. As seen in FIG. 6, a SSL handshake with server authentication is initiated by the client 20. Such a handshake may include an exchange of information between the client and the server. This exchange of information is called SSL handshake. Application Program Interfaces (APIs) for performing the SSL handshake to establish and/or manage SSL connections and communicate using such connections are available. For example, Java Secure Socket Extension (JSSE) and/or openSSL provide a framework and implementation for the SSL and TLS protocols and include functionality for data encryption, server authentication, message integrity and optional client authentication.

While conventional APIs provide for SSL handshake and communication and need not be described further herein, in some embodiments of the present invention, the SLL handshake my include the following steps:
(1) Client Hello: The client sends the server information including the highest version of SSL protocol it supports (TLS 1.0 may be indicated as SSL 3.1. TLS: transport Layer Security) and a list of the cipher suites it supports. The cipher suite information includes cryptographic algorithms and key sizes. The cipher suite list is sorted with client's first preference first. The client may specify only one cipher suite in the list at each side for more controls and improving performance, for example, SSL_RSA_WITH_RC4_{—}128_SHA.
(2) Server Hello—The server chooses the lower version of SSL protocol suggested by the client and the highest one supported by the server and returns the best cipher suite that both the client and server support and sends this information to the client. Like the client, the server also has a list of supported cipher suites sorted by the server's first preference first. If the client and server both specify cipher suite SSL_RSA_WITH_RC4_{—}128_SHA, the info about the cipher suite will be sent back. The client hello in Step 1) and the server hello in Step 2) will establish the following major attributes:
   a) protocol version
   b) session ID
   c) cipher suite and etc.
(3) Certificate—The server sends the client the server public key certificate or certificate chain. This message is optional in SSL, but is used for authentication of the server according to some embodiments of the present invention. The public certificate of the server is self-signed in X.509 format. For encryption/decryption only connections, this step may be skipped. However, the public/private key pair of the server still may be needed for key exchange in Step 5) for the purpose of symmetric encryption.
(4) Certificate request—If the server needs to authenticate the client, it sends the server a certificate request. In both JSSE and OpenSSL, an API is provided that could be used at the server side to specify client authentication explicitly. This step is optional and the server need not request authentication of the client.
(5) Server key exchange—The server sends the client a server key exchange message when the public key information sent in 3) above is not sufficient for key exchange.
(6) Server hello done—The server tells the client that it is finished with its initial negotiation messages.
(7) Certificate—If the server requests a certificate from the client for authentication of the client in Step 4), the client sends its public key certificate, just as the server did in Step 3).
(8) Client key exchange—The client generates information used to create a key to use for symmetric encryption. For authentication and key exchange algorithm: RSA, the client then encrypts this key information with the server public key and sends it to the server. The key is called a secret key or session key and is used to encrypt the data after the connection is set up.
(9) Certificate verify—In order for the server to authenticate the client, the client sends information that it digitally signs using a cryptographic hash function and the client's private key. When the server verifies this information with the public key of the client, the server is able to authenticate the client. The client may the same method to authenticate the server. This is the default authentication logic from X.509 certificate provided external packages like JSSE and OpenSSL. If the default authentication logic is not suitable, alternative authentication logic could be provided by customizing APIs from the packages (overwriting some methods from X.509 certificate class).
(10) Change cipher spec—The client sends a message telling the server to change to encrypted mode.
(11) Finished—The client tells the server that it is ready for secure data communication to begin.
(12) Change cipher spec—The server sends a message telling the client to change to encrypted mode.
(13) Finished—The server tells the client that it is ready for secure data communication to begin. This is the end of the SSL handshake.
(14) Encrypted data—The client and the server communicate with each other using the symmetric encryption algorithm and the cryptographic hash function negotiated in Steps 1 and 2, and using the secret key that the client sent to the server in Step 8.

As discussed above, in Step 3, the server sends its public key certificate to the client. The public key certificate is self-signed by its private key to ensure the validity of the certificate. During the initial SSL handshake, the server presents its public key certificate with digital signature (self-signed by its private key) to the client and the client will use the server public key from its key store to verify the digital signature. If the verification is successful, the server is authenticated by the client. However, as illustrated in FIG. 6, if the verification is not successful, the authentication will fail and an SSL encryption only handshake will be performed.

After establishing the encryption only SSL connection, as a result of the authentication failure, the client 20 automatically sends a request for a new public key to the server 10 and receives the new public key back. The client may then establish an SSL session with server authentication using the new public key.

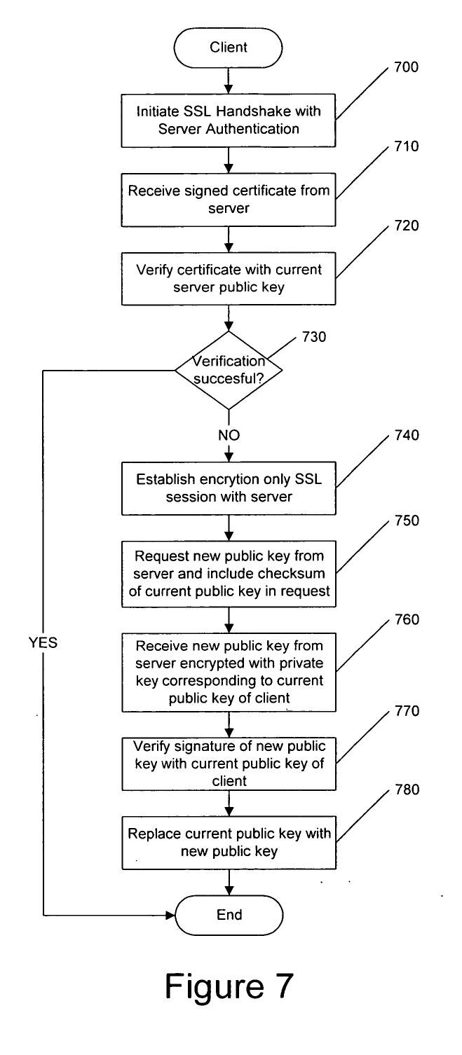

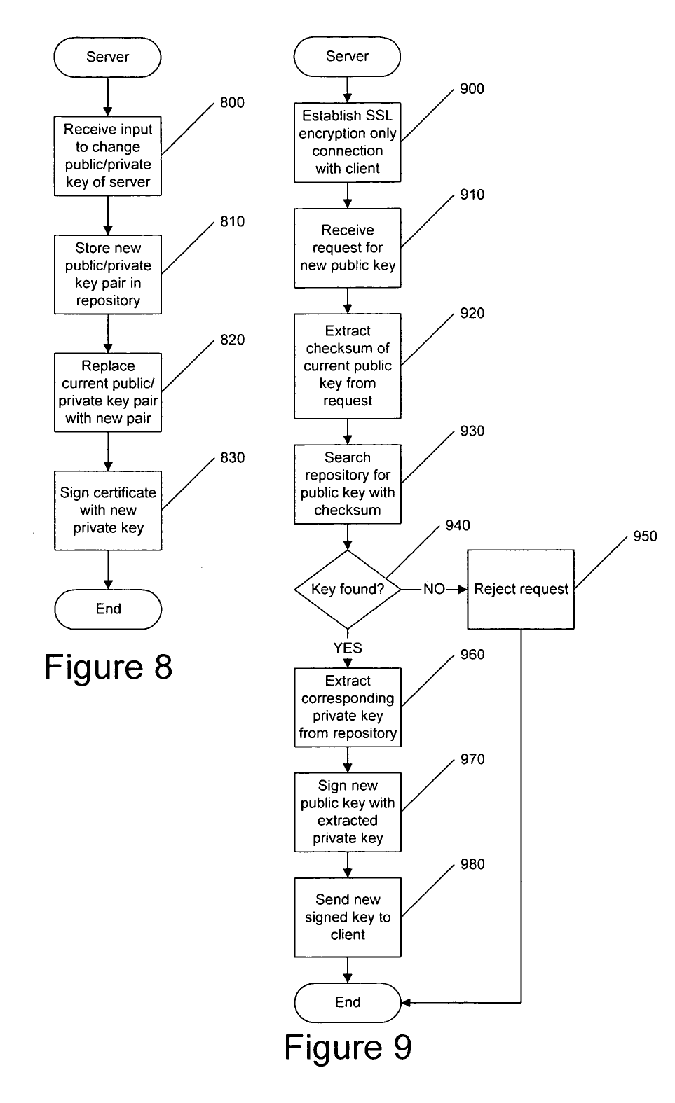

FIGS. 7 through 9 illustrate operations of a client 20 and a server/authentication server 10 for automatic rekeying according to certain embodiments of the present invention. Operations of a client are illustrated in FIG. 7 and operations of a server/authentication server 10 are illustrated in FIGS. 8 and 9. FIG. 8 illustrates operations for changing a public/private key pair at the server/authentication server 10 and FIG. 9 illustrates operations for automatically distributing the new key information from the server/authentication server 10 to a client 20.

As seen in FIG. 7, the client initiates an SSL handshake with server authentication as described above (block 700). The client receives a signed certificate from the server for authentication (block 710). The client attempts to verify the signature of the received certificate using the public key stored at the client that is associated with the server (block 720). If the client 20 successfully verifies the signature of the certificate (block 730), the server is authenticated and communications continue in a conventional manner. However, if the client 20 fails to successfully verify the signature of the certificate (block 730), the server authentication has failed and the client establishes an encryption only SSL session with the server (block 740).

After establishing the encryption only SSL session (block 740), the client request a new, updated, public key from the server (block 750). The request for the new public key may include the checksum of the current public key associated with the server that is stored by the client. The checksum may be used by the server to validate the client and to determine the public/private key pair for which the client has the public key stored as its current public key associated with the server.

In response to the request for a new public key, the client receives the new public key from the server (block 760). The new public key may be signed with the private key of the public/private key pair that correspond to the current public key stored at the client (i.e. the private key that corresponds to the public key having the checksum provided by the client in the request).

The client verifies the signature of the received new public key with its current public key (block 770). The client replaces the current public key in its key store with the decrypted new (updated) public key (block 780). Thus, the client detects that its current public key is out of date as a result of an authentication failure and automatically obtains and installs a new public key of the server for which authentication has failed.

FIG. 8 illustrates operations of a server for updating its public/private key pair. As is known to those of skill in the art, in certain encryption techniques, such as RSA, a private key and a public key are used for encryption and decryption. These keys are collectively referred to herein as a public/private key pair. As seen in FIG. 8, the server receives input to change its current public/private key pair (block 800). This input may, for example, be provided by a user invoking a utility that generates new public/private key pairs. For example, in an AppManager Unix system, the user may invoke a modified version of the utility NQKeyGenUnix to update public/private key pairs. For example, the NQKeyGenUnix utility may be updated to include the following parameters of the program.
db db_name:user_name:user_password:sql_server_name
   used for unix key communication; must fill out qdb connection info
new password
   creates the entry in the qdb for public/private key pair used for encrypted communication with unix agents
change password—skey filelocation
   changes the pub/priv key pair file in the qdb to the key file specified
ckey filelocation
   extract just the public key of the key file stored in qdb
skey filelocation
   extract the public/private key file stored in qdb
seclev xx
   sets security level in the AM repository for Unix agent-MS communication
      0=no security, 1=encryption only, 2=MS authentication 9=remove all historical key-pairs while maintaining the current security level
new password—skey filelocation
   create a keyfile for server and store in appropriate location
      Usage Scenarios [—new password—skey . . . ]
This option will create a new private/public key pair with password protection in a file format. It is used primarily for multiple QDB environments where users will want to copy the file from place to place and check the same key files into the all the QDB. This will make the key management a bit simpler. If an older one exists, then it will automatically be marked as historical for use in rekeying efforts.
   Usage Scenarios [—db . . . —new password]
This option is used when users wants to create a new key pair. If an older one exists, then it will automatically be marked as historical for use in rekeying efforts. The password must be entered and should be remembered if at a later point the user will want to “checkout” the key and reinstall it in different QDB.
   Usage Scenarios [—db . . . —seclev]
This option can set the security level of the QDB. The new level will not take effect until the attached MS is restarted. Also, this option with 9 will remove all historical key-pairs while maintaining the current security level. By removing the historical key pairs, the users can manually “expire” the older keys as user's own security requirements dictate.
   Usage Scenarios [—db . . . —change]
This option would be used when user wants to “check-in” an existing key from a key file. This would happen again for multiple QDB environments where users want to share the key file among all the QDBs/MSs.
   Usage Scenarios [—db . . . —ckey]
Once a key pair is installed into a QDB, this option will take the current key pair and extract the client portion of the key (i.e. public key) in a “pem” format. This file then can be copied to the Agent site for use by the Agent.
   Usage Scenarios [—db . . . —skey]
This option is used to “checkout” the current key pair into a password protected file format. This file then can be checked into a different QDB using the—change option.

Alternatively, the input may be programmatically generated so as to automatically update the public/private key pairs periodically, for example, as part of an automated maintenance procedure.

However the new public/private key pairs are generated, the new public/private key pair is stored in the key repository (block 810). The current public/private key pair is replaced with the new public/private key pair for use by the server in communications (block 820) and the certificate of the server is signed with the new private key (block 830).

In addition to the generation of new public/private key pairs, the key repository may also be maintained, for example, by the removal of historic values. Thus, for example, the key repository may be purged of prior key values while maintaining the current key values. Particular key values could also be removed selectively, for example, by age or by determinations that such key values were no longer being used by any client with access to the server. Such maintenance of the key repository may be manual or automatically performed. For example, the server/authentication server 10 may maintain a list of all clients with which the server would be authenticated and remove keys from the key repository when all clients have had their keys updated to a more recent public key.

FIG. 9 illustrates operations of the server to provide a new public key to a client. As seen in FIG. 9, an encryption only SSL connection is established with the client (block 900). The server receives a request for a new public key from the client over the established connection (block 910). The server extracts the identification of the client's current public key, for example, the checksum of the current public key of the client, from the request (block 920) and searches the key repository for a public key with a checksum corresponding to that provided by the client (block 930). In certain embodiments of the present invention, the checksum of the public key is stored in the key repository to facilitate such searching. In other embodiments of the present invention, the checksum is calculated from the public keys stored in the key repository at the time of searching. In still other embodiments, the checksum of recent public keys may be stored and of older public keys calculated. Additionally, searching techniques, such as hash searches or the like, may also be utilized to facilitate more rapid searching.

In any event, if a public key is not found in the key repository that has a checksum corresponding to the checksum provided in the request from the client (block 940), the request is rejected (block 950). The rejection of the request may terminate communications with the client and/or generate an error log entry indicating the failure. Communications with the client could also be continued in a non-secure manner and the rejection of the request would terminate secure communications. Appropriate action could be taken on the part of the client so as to limit, adjust and/or modify the information provided to the server in light of the failure to establish a secure connection.

If a public key is found in the key repository that has a checksum corresponding to the checksum provided in the request from the client (block 940), the corresponding private key is extracted from the repository (block 960). The new public key is signed with the private key extracted from the repository (block 970) and the signed new public key is sent to the client over the encryption only SSL connection (block 980).

While embodiments of the present invention have been described with reference to clients and servers, such terms are used in a generic sense. Thus, a client may be any data processing system/device that authenticates communications from another data processing system/device and a server may be any data processing system/device that is authenticated by another data processing system/device. Thus, the term client refers to an authenticating system/device and the term server refers to an authenticated system/device. Thus, embodiments of the present invention may include, for example, server-side authentication systems, client-side authentication systems and/or two-way authentication systems.

Furthermore, while embodiments of the present invention have been described with reference to system monitoring systems, certain embodiments of the present invention may be applicable to other systems. For example, in an e-mail system a recipient of an e-mail may verify authentication of a sender (e.g., either the author or an e-mail server) of an e-mail against a local store or authenticated and/or encrypted e-mail senders. If the recipient fails to authenticate the sender, the recipient may automatically access an authentication server to obtain a new public key associated with the sender. If a new public key is available, the e-mail may be verified with the new public key. Such an authentication system could, for example, be provided in a conventional e-mail system, such as Microsoft Exchange, utilizing a plug-in for the automatic re-keying of the e-mail recipient. Thus, in certain embodiments of the present invention, authenticity of a communication may be verified and, upon failure of that verification, a public key may be automatically updated.

The flowchart and block diagrams of FIGS. 1 through 9 illustrate the architecture, functionality, and operations of some embodiments of methods, systems, and computer program products for automatic rekeying in a server-side authentication environment. In this regard, each block represents a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method of rekeying in an authentication system including an authenticated data processing system and an authenticating data processing system, comprising the following carried out by the authenticating data processing system:
detecting failure of an authentication of the authenticated data processing system with a current public key associated with the authenticated data processing system; and
automatically updating the current public key associated with the authenticated data processing system with an updated public key responsive to detecting failure of an authentication of the authenticated data processing system with the current public key.

2. The method of claim 1, wherein the authentication system comprises a server-side authentication system, the authenticated data processing system comprises an authenticated server and the authenticating data processing system comprises a client of the authenticated server, and wherein detecting failure comprises detecting failure of an authentication of the authenticated server with a current public key associated with the authenticated server; and
wherein automatically updating comprises automatically updating the current public key associated with the authenticated server with an updated public key responsive to detecting failure of an authentication of the authenticated server with the current public key.

3. The method of claim 2, wherein detecting failure of an authentication of the authenticated server comprises:
receiving a signed certificate from the authenticated server; and
failing to verify the signed certificate with the current public key.

4. The method of claim 2, wherein automatically updating the current public key associated with the authenticated server comprises:
establishing a connection to an authentication server;
requesting the updated public key from the authentication server over the established connection;
receiving the updated public key over the established connection; and
replacing the current public key at the client with the received updated public key.

5. The method of claim 4, wherein establishing a connection to the authentication server comprises establishing a secure connection to the authentication server.

6. The method of claim 3, wherein the secure connection comprises a Secure Sockets Layer encryption only connection.

7. The method of claim 4, wherein the authenticated server and the authentication server comprise a single server.

8. The method of claim 4, wherein requesting the updated public key from the authentication server comprises sending a request for an updated public key to the authentication server, the request including an identification of the current public key.

9. The method of claim 8, wherein the identification of the current public key comprises a checksum of the current public key.

10. The method of claim 4, wherein receiving the updated public key comprises:
receiving the updated public key signed with a private key corresponding to the current public key; and
verifying a signature of the received signed updated public key with the current public key.

11. The method of claim 2, wherein the authenticated server comprises a system monitoring server and the client comprises a resource monitoring agent.

12. The method of claim 1, wherein the authenticated data processing system comprises a client and the authenticated data processing system comprises a server.

13. A method of rekeying in a server-side authentication system including a server, the method comprising the following:
receiving a request for an updated public key from a client over a connection established responsive to the client detecting failure of an authentication of the server by the client; and
providing the updated public key from the server to the client responsive to receiving the request for the updated public key from the client.

14. The method of claim 13, wherein the connection comprises an encryption only secure connection to the server.

15. The method of claim 14, wherein the secure connection comprises a Secure Sockets Layer encryption only connection.

16. The method of claim 13, wherein the request for an updated public key includes an identification of a current public key of the client.

17. The method of claim 16, wherein the identification of the current public key comprises a checksum of the current public key.

18. The method of claim 16, further comprising validating the client as authorized to request an updated public key based on the identification of the current public key of the client.

19. The method of claim 16, further comprising:
selecting a private key from a repository of public/private key pairs based on the identification of the current public key; and
wherein providing the updated public key further comprises:
signing the updated public key utilizing the selected private key; and
sending the signed updated public key to the client over the secure connection.

20. The method of claim 13, further comprising storing the current public/private key pair of the server in a key repository.

21. The method of claim 20, further comprising signing an authentication certificate of the server with the updated private key.

22. The method of claim 13, wherein the client further carries out the following:
automatically requesting updating of the current public key of the client associated with the server with an updated public key responsive to detecting failure of an authentication of the server with the current public key.

23. The method of claim 22, wherein the client detecting failure of an authentication of the server comprises:
receiving a signed certificate from the server; and
failing to verify a signature of the signed certificate with the current public key.

24. The method of claim 22, further comprising the client carrying out the following:
receiving the updated public key from the server; and
replacing the current public key with the updated public key.

25. The method of claim 24, wherein receiving the updated public key comprises:
receiving the updated public key signed with a private key corresponding to the current public key; and
verifying a signature of the received signed updated public key with the current public key.

26. The method of claim 13, wherein the server comprises a system monitoring server and the client comprises a resource monitoring agent.

27. A system for rekeying a server-side authentication system, comprising:
a first client configured to detect failure of the first client to authenticate an authenticated server and to automatically request an updated public key associated with the authenticated server for which authentication failure was detected; and
an authentication server configured to receive requests for updated public keys from the first client and send updated public keys to the first client.

28. The system of claim 27, further comprising a key repository operably associated with the authentication server, the key repository being configured to store previous public/private key pairs associated with the authenticated server.

29. The system of claim 28, wherein the authentication server is further configured to select a public/private key pair from the key repository corresponding to a current public key of the first client from which a request was received and sign the updated public key with a private key of the selected public/private key pair.

30. The system of claim 29, wherein the first client is further configured to receive the updated public key from the authentication server and to verify a signature of the received updated public key with the current public key of the first client.

31. The system of claim 29, further comprising a second client configured to detect failure of the second client to authenticate an authenticated server and automatically request an updated public key associated with the authenticated server for which authentication failure was detected; and
wherein the authentication server is further configured to receive requests for updated public keys from the second client and send updated public keys to the second client.

32. The system of claim 31, wherein the authentication server is further configured to select a public/private key pair from the key repository corresponding to a current public key of the first client from which the request was received and sign the updated public key with a private key of the selected public/private key pair and to select a public/private key pair from the key repository corresponding to a current public key of the second client from which the request was received and sign the updated public key with a private key of the selected public/private key pair.

33. The system of claim 32, wherein the selected public/private key pair from the key repository corresponding to a current public key of the second client and the selected public/private key pair from the key repository corresponding to a current public key of the first client are different public/private key pairs.

34. An authenticating data processing system for use in a system for rekeying in an authentication system including an authenticated data processing system, comprising:
means for detecting failure of an authentication of the authenticated data processing system with a current public key associated with the authenticated data processing system; and
means for automatically updating the current public key associated with the authenticated data processing system with an updated public key responsive to detecting failure of an authentication of the authenticated data processing system with the current public key.

35. The authenticating data processing system of claim 34, wherein the authentication system comprises a server-side authentication system, the authenticating data processing system comprises a client and the authenticated data processing system comprises a server.

36. A computer program product for rekeying in an authentication system including an authenticating data processing system and an authenticated data processing system, the computer program product comprising:
a computer readable medium having computer readable program code embodied therein, the computer readable program code comprising:
computer readable program code configured to detect failure of an authentication of the authenticated data processing system with a current public key associated with the authenticated data processing system; and
computer readable program code configured to automatically update the current public key associated with the authenticated data processing system with an updated public key responsive to detecting failure of an authentication with the current public key.

37. The computer program product of claim 36, wherein the authentication system comprises a server-side authentication system, the authenticating data processing system comprises a client and the authenticated data processing system comprises a server.

38. A method of rekeying in an authentication system having an authenticated communication, comprising the following carried out by an authenticating data processing system:
detecting failure of an authentication of an authenticated communication with a current public key associated with a source of the authenticated communication; and
automatically updating the current public key associated with the source of the authenticated communication with an updated public key responsive to detecting failure of an authentication of the authenticated communication with the current public key.

39. The method of claim 38, wherein the authenticated communication comprises a signed certificate, the authenticating data processing system comprises a client and the source of the authenticated communication comprises a server.

40. The method of claim 38, wherein the authenticated communication comprises a signed certificate, the authenticating data processing system comprises a server and the source of the authenticated communication comprises a client.

41. The method of claim 38, wherein the authenticated communication comprises an e-mail message, wherein the authenticating data processing system comprises a mail recipient and the source of the authenticated communication comprises a source of the e-mail message.

42. The method of claim 41, wherein the source of the e-mail message comprises an author of the e-mail.

43. The method of claim 41, wherein the source of the e-mail message comprises an e-mail server.
